(19) United States
(12) Patent Application Publication
(10) Pub. No.: US 2025/0178489 A1
(43) Pub. Date: Jun. 5, 2025

(54) CHILD SEAT POSITION DETECTION METHOD AND ASSOCIATED DETECTION SYSTEM

(71) Applicant: FAURECIA Sièges d'Automobile, NANTERRE (FR)

(72) Inventors: Mamadou BALDE, MORIGNY-CHAMPIGNY (FR); Abdou Latif DJIRAM, CHILLY-MAZARIN (FR); Theo DESGROLARD, PALAISEAU (FR)

(21) Appl. No.: 18/962,097

(22) Filed: Nov. 27, 2024

(30) Foreign Application Priority Data
Nov. 30, 2023 (FR) 2313348

(51) Int. Cl. B60N 2/26; G01D 5/24

(52) U.S. Cl. CPC B60N 2/268; G01D 5/2405

(57) ABSTRACT

The present disclosure relates to a method for detecting a so-called front position or a so-called rear position of a child seat arranged on a vehicle seat; the method further comprising the following steps:
a) calculating a first mean value from the capacitive values measured during a first period of the measurement phase,
b) calculating a second mean value of the capacitive values measured during a second period of the measurement phase, the second period being subsequent to the first period,
c) calculating a first variation between the second mean value and the first mean value,
d) comparing the first variation with a first threshold,
e) transmitting a first signal indicative of a detection of a forward position of the child seat, when the first variation is greater than the first threshold. The present disclosure also relates to an associated detection system.

### PRIORITY CLAIM

This application claims priority to French Patent Application No. FR2313348, filed Nov. 30, 2023, which is expressly incorporated by reference herein.

### BACKGROUND

The present disclosure relates to a method for detecting a so-called front position or a so-called rear position of a child seat arranged on a vehicle seat and an associated detection system.

### SUMMARY

According to the present disclosure, a method for detecting a so-called front position or a so-called rear position of a child seat arranged on a vehicle seat is disclosed. The method being implemented by a detection system comprising a vehicle seat having a seat and a backrest having a front face with two longitudinal edges, at least one first capacitive sensor with coplanar interdigital electrodes attached to the backrest at a first distance from the seat, a detection device able to detect the presence of a child seat on the vehicle seat, and a processing unit connected to the at least one first capacitive sensor and to the detection device; the first distance being between 30 centimeters and 45 centimeters; the method comprising a measurement phase during which capacitive values are measured at the electrodes of the at least one first capacitive sensor; upon detection of the presence of a child seat on the vehicle seat, the method further comprising the following steps:
a) calculating a first mean value from the capacitive values measured during a first period of the measurement phase,
b) calculating a second mean value of the capacitive values measured during a second period of the measurement phase, the second period being subsequent to the first period,
c) calculating a first variation between the second mean value and the first mean value,
d) comparing the first variation with a first threshold,
e) transmitting a first signal indicative of a detection of a front position of the child seat, when the first variation is greater than the first threshold.

The features disclosed in the following paragraphs may optionally be implemented. They can be implemented independently of one another or in combination with one another:
The first threshold is between 15 picofarads and 50 picofarads.
The detection system comprises a second capacitive sensor with coplanar interdigital electrodes arranged on the backrest, the first and second capacitive sensors being arranged on either side of a central longitudinal plane; the central longitudinal plane extending vertically, between and halfway between the two longitudinal edges; steps a) to d) being implemented by the processing unit based on the capacitance values measured at the electrodes of the second capacitive sensor, a first signal representing a detection of a front position of the child seat being transmitted only if the first variation calculated based on the capacitive values from the first capacitive sensor and the first variation calculated based on the capacitive values from the second capacitive sensor are each greater than the first threshold.
The detection system further comprises at least one additional coplanar interdigital electrode capacitive sensor arranged on the backrest; the additional capacitive sensor being located at a third distance from the seat, the third distance being between 20 centimeters and 30 centimeters; capacitive values being measured at the electrodes of the at least one additional capacitive sensor during the measurement phase, and wherein, when the at least one first variation is below the first threshold, the method further comprises the following steps:
calculating a third mean value from the capacitive values measured by the additional capacitive sensor during the first period,
calculating a fourth mean value from the capacitive values measured by the additional capacitive sensor during the second period,
calculating a second variation between the fourth mean value and the third mean value,
comparing the second variation with the first threshold;
transmitting a second signal indicating that the child seat is intended for a child under eighteen months of age.

The present disclosure also relates to a system for detecting a front or rear position of a child seat arranged on a vehicle seat, the detection system comprising:
a vehicle seat comprising a seat and a backrest, the backrest having two longitudinal edges,
at least one first coplanar interdigital capacitive sensor arranged on the backrest at a first distance from the seat, the first distance being between 30 centimeters and 45 centimeters from the seat,
a detection device able to detect the presence of a child seat on the vehicle seat,
a data processing unit connected to the at least one first capacitive sensor and to the detection device, the processing unit comprising a memory including instructions for implementing the above-described method.

The features disclosed in the following paragraphs may optionally be implemented. They can be implemented independently of one another or in combination with one another:
The at least one first capacitive sensor is arranged midway between the longitudinal edges of the front face of the vehicle seat back.
The system further comprises a second capacitive sensor with coplanar interdigital electrodes arranged on the backrest, the first and second capacitive sensors being arranged on either side of a central longitudinal plane; the central longitudinal plane extending vertically between and midway between the two longitudinal edges; the memory comprising instructions for implementing the steps of the method described above.
The first capacitive sensor and the second capacitive sensor are separated from the central longitudinal plane by a second distance of between 1 centimeter and 5 centimeters.
The detection system further comprises at least one additional coplanar interdigital electrode capacitive sensor arranged on the backrest; the additional capacitive sensor being located at a third distance from the seat, the third distance being between 20 centimeters and 30 centimeters; the memory comprising instructions for implementing the steps of the method described above.
The additional capacitive sensor is arranged midway between the longitudinal edges of the front face of the vehicle seat back.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a vehicle seat and a child seat arranged on the seat; the child seat being in a front position;

FIG. 2 is a perspective view of a vehicle seat and a child seat arranged on the seat, the child seat being in a rear position;

FIG. 3 is a perspective view of a detection system according to a first embodiment;

FIG. 4 is a perspective view of a detection system according to a second embodiment;

FIG. 5 is a perspective view of a detection system according to a third embodiment;

FIG. 6 is a perspective view of a detection system according to a fourth embodiment;

FIG. 7 is a diagram showing the steps of a detection method according to a first embodiment;

FIG. 8 is a diagram showing the steps of a detection method according to a second embodiment; and

FIG. 9 is a diagram showing the steps of a method according to a third embodiment.

### DETAILED DESCRIPTION

In the following description, spatial positioning indications such as front, rear, top, bottom, upper, lower, horizontal, vertical etc. are to be interpreted according to the usual position of use of a seat in a vehicle. Forward direction is the direction of a vehicle moving forward. In particular, the front face of a backrest is the face on which the back of a seat occupant rests.

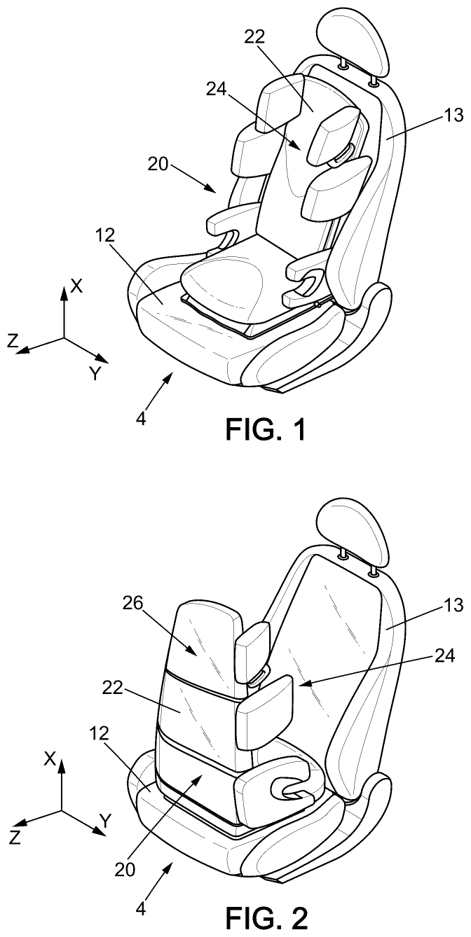

The present disclosure is described in connection with the orthonormal (X, Y, Z) coordinate system shown in FIGS. 1 and 2.

FIGS. 1 and 2 show a child seat 20 attached to a motor vehicle seat 4. The child seat 20 comprises a backrest 22 having a reception face 24 configured to receive a child's back and a rear face 26 opposite the reception face. In FIG. 1, the child seat 20 is positioned in a “front position” in which the rear face 26 of the child seat faces a backrest 13 of the vehicle's passenger seat. In FIG. 2, the child seat 20 is positioned in a so-called “rear position” in which the child seat's reception face 24 faces the backrest 13 of the vehicle's passenger seat.

The detection system 2 according to the present disclosure is configured to determine the position of the child seat 20 between the so-called “front position” and the so-called “rear position”. The detection system 2 according to the first embodiment only works for child seats over 18 months of age.

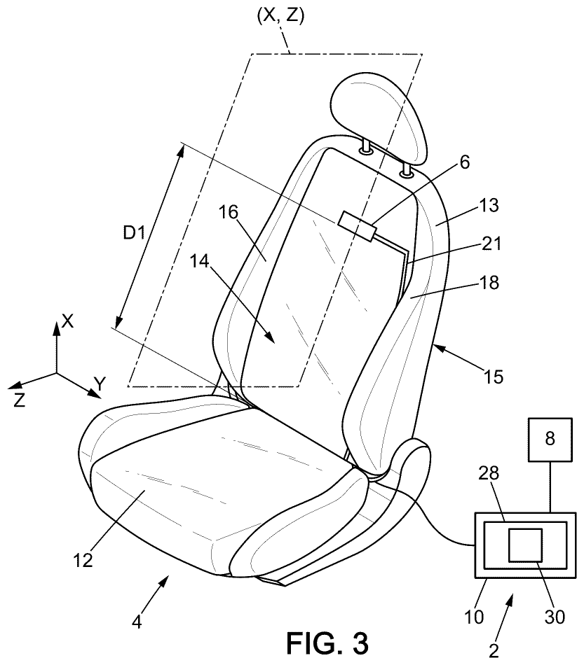

FIG. 3 shows an example of a detection system 2 according to a first embodiment of the present disclosure. This detection system 2 according to the first embodiment only works for child seats intended for children over 18 months of age.

This detection system comprises a seat 4, a first capacitive sensor 6 with coplanar interdigital electrodes, a detection device 8 and a processing unit 10 connected to the first capacitive sensor 6 and to the detection device.

The seat 4 comprises a seat 6 and a backrest 13 which is articulated to the seat.

Backrest 13 comprises a supporting structure, a foam layer carried by the supporting structure and a textile-type outer covering over the foam layer. The backrest 13 comprises a front face 14 able to receive the seat occupant's back and a rear face 15 opposite the front face. The front face 14 of the backrest has two longitudinal edges 16, 18 opposite one another.

For the purposes of this description, a central longitudinal plane (X, Z) perpendicular to the seat back is defined. The central longitudinal plane (X, Z) is vertical. The central longitudinal plane (X, Z) intersects the center of the backrest width. That is, it is located midway between the two longitudinal edges 16, 18 of the front face of the backrest.

The first capacitive sensor 6 is attached to the backrest at a first distance D1 from the seat. The first distance D1 is between 30 centimeters and 45 centimeters. The first distance DI is measured substantially along the X axis. The first distance D1 is measured between the rear part of the substantially horizontal face of the seat and the lower part of the capacitive sensor, as shown in FIG. 3. The first distance is the smallest distance between the substantially horizontal part of the seat and the lower part of the capacitive sensor.

In the first embodiment, the first capacitive sensor 6 is arranged midway between the longitudinal edges 16, 18 of the vehicle seat back.

The first capacitive sensor 6 is arranged between the foam layer and the outer backrest cover. The first capacitive sensor 6 can be attached to a flexible support attached against the foam layer of the backrest. The flexible support is not shown in the figures.

The first capacitive sensor 6 comprises two electrodes. Each electrode comprises a rod and fingers attached to the rod. The fingers extend perpendicular to the rod. The fingers are spaced apart in a comb-like configuration. The second electrode is positioned relative to the first electrode so that the fingers of the second electrode are interposed between the fingers of the first electrode. An example of the dimensions of the rods, fingers and spacings between the rods and fingers of the first capacitive sensor is described in the patent application published under number FR3126776 and incorporated by reference herein in its entirety.

An electrode is connected to a voltage source via an electrical connection wire 21. The voltage source generates a voltage of, for example, 5 volts. The second electrode is connected to ground via an electrical connection wire 21.

The detection device 8 is able to detect the presence of a child seat on the vehicle seat. Detection device 8 can be any suitable device for this purpose.

According to a first example, the detection device 8 comprises, for example, several capacitive sensors arranged on the seat and connected to a processing unit capable of implementing a method for recognizing the presence of a child seat on the seat. A method of the same type as that described in patent FR2012255 could, for example, be used by adding one or more sensors to the backrest and/or by receiving information from other sensors of the vehicle, such as the seatbelt tension sensor and is incorporated by reference herein in its entirety.

According to a second example, the detection device 8 is, for example, a camera capable of capturing images of the front passenger seat, a processing unit capable of implementing a child seat detection method based on image contour recognition from the images captured by the camera.

According to a third example, the detection device 8 can also be a control button that can be operated by a vehicle occupant.

The processing unit 10 periodically measures capacitance values between the electrodes of the first capacitive sensor 6.

The data processing unit 10 can be a programmable device or a processor using software or a specific integrated circuit (ASIC). The processing unit 10 comprises a memory 28 which stores an executable code for implementing the detection method described below based on the capacitance values received from the first capacitive sensor 6. The memory 28 comprises a random-access memory, denoted RAM and a read-only memory, denoted ROM.

Memory 28 contains instructions 30 for implementing the detection method according to the first embodiment of the present disclosure described below.

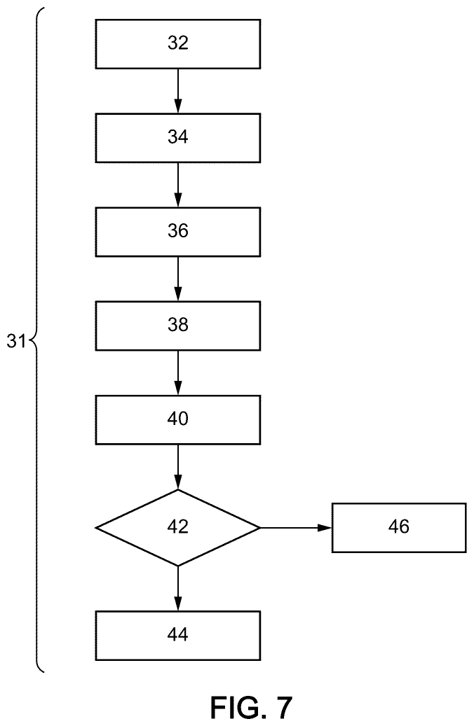

With reference to FIG. 7, the detection method according to the first embodiment 31 of the present disclosure comprises a measurement phase 32 during which capacitive values are measured by the processing unit at the electrodes of the first capacitive sensor 6. The measurement phase 32 comprises several periods of the same duration. The measurement periods last between 1 and 5 seconds. Capacitive values are measured every 100 milliseconds.

In a step 34, the detection device 8 detects the presence of a child seat 20 on the seat 4.

In a step 36, a first mean value M1 is calculated from the capacitive values measured over a first period.

In a step 38, a second mean value M2 is calculated from the capacitive values measured during a second period subsequent to the first period.

In a step 40, the difference between the second mean value M2 and the first mean value M1 is calculated. This difference is called a first variation Δ1.

In a step 42, the first variation Δ1 is compared with a first threshold Se1.

The first threshold Se1 is between 15 picofarads and 50 picofarads. Preferably, the first threshold Se1 is equal to 20 picofarads.

If the variation Δ1 is greater than the first threshold Se1, the processing unit transmits a first signal Sig1 representing the detection of a front position of the child seat, in a step 44.

If the variation Δ1 is less than the first threshold Se1, a signal Sig3, referred to as the third signal Sig3, representing a detection of a rear position of the child seat is transmitted by the processing unit, during a step 46.

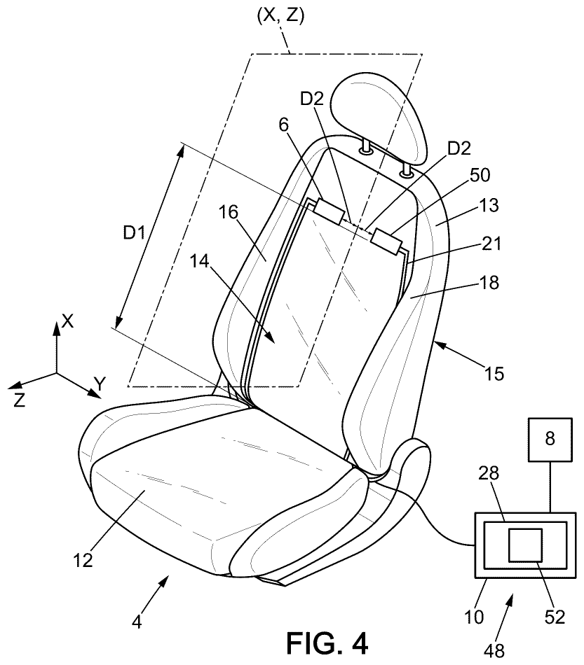

A detection system 48 according to a second embodiment is shown in FIG. 4. This detection system 48 according to the second embodiment only works for child seats intended for children over 18 months of age. The detection system 48 according to this second embodiment is identical to the detection system 2 according to the first embodiment, except that it comprises a second capacitive sensor 50 with coplanar interdigital electrodes arranged on the backrest 13, and the processing unit implements a method according to a second embodiment.

The first capacitive sensor 6 and the second capacitive sensor 50 are arranged on either side of the central longitudinal plane (X, Z). The first capacitive sensor 6 and the second capacitive sensor 50 are each located at a first distance DI from the nearest part of the seat, as shown in FIG. 4.

The first capacitive sensor 6 and the second capacitive sensor 50 are separated from the central longitudinal plane (X, Z) by a second distance D2. The second distance is the shortest distance to the center plane. The second distance is between 1 cm and 5 cm. The second distance is measured along the Y axis.

Memory 28 includes instructions 52 for implementing the detection method steps according to the second embodiment described below.

The other technical elements of the detection system 48 according to the second embodiment are identical to the technical elements of the detection system 2 according to the first embodiment; they bear the same references and will not be described a second time.

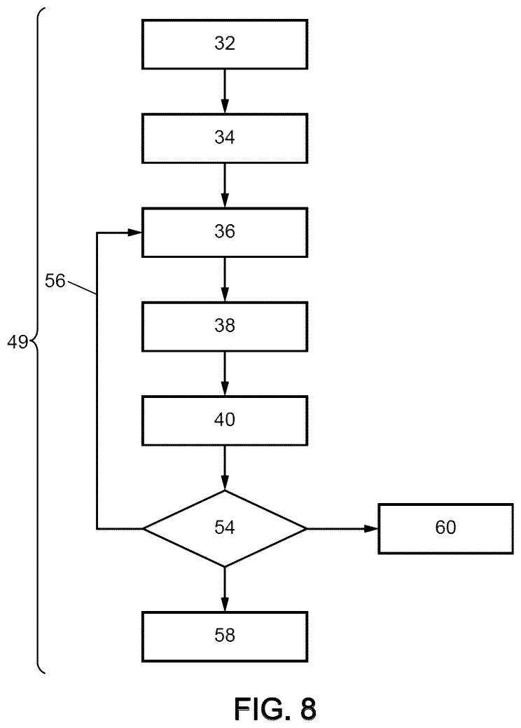

The detection method according to the second embodiment of the present disclosure 49 is implemented by the detection system according to the second embodiment. The detection method according to the second embodiment is shown in FIG. 8. It is identical to the detection method according to the first embodiment, except that during the measurement phase 32, capacitive values are measured by the processing unit at the electrodes of the first capacitive sensor 6 and at the electrodes of the second capacitive sensor 50.

After detecting the presence of a child seat 20 on the seat 4, steps 36 to 40 are carried out for the capacitance values measured at the electrodes of the first capacitive sensor 6.

Then, in a step 54, the variation Δ1 calculated in step 42 is compared with the first threshold Se1.

If the variation Δ1 is greater than the first threshold Se1, the method returns to step 36 in a step 56 and steps 36 to 54 are performed again based on the capacitance values measured at the electrodes of the second capacitive sensor 50.

In step 54, the first variation Δ1 calculated from the capacitive values from the second capacitive sensor 50 is compared with the first threshold Se1.

If the first variation Δ1 calculated from the capacitive values from the second capacitive sensor 50 is greater than the first threshold Se1, then a first signal Sig1 indicative of a detection of a front position of the child seat is transmitted during a step 58.

Thus, in this embodiment, a first signal Sig1 indicative of a detection of a front position of the child seat is transmitted only if the first variation Δ1 calculated based on the capacitive values from the first capacitive sensor and the first variation Δ1calculated based on the capacitive values from the second capacitive sensor 50 are each greater than the first threshold Se1.

If the first variation Δ1 calculated based on the capacitive values from the first capacitive sensor and/or the first variation Δ1 calculated based on the capacitive values from the second capacitive sensor 50 is less than the first threshold Se1, then a third signal Sig3 indicative of a detection of a rear position of the child seat is transmitted by the processing unit, during a step 60.

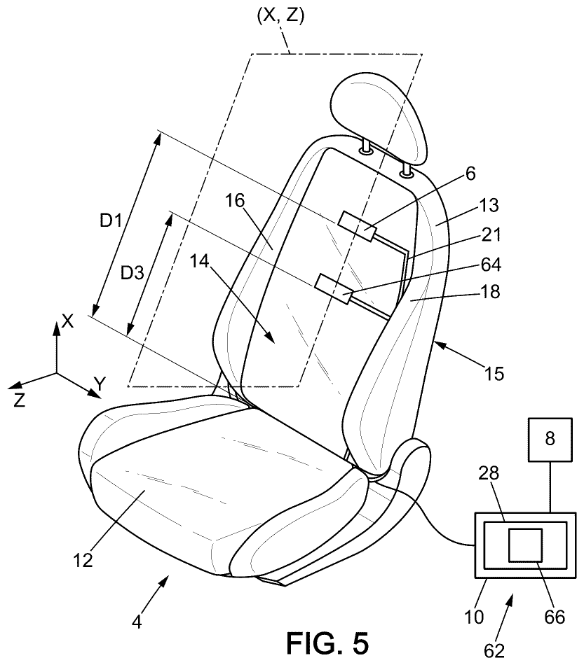

A detection system 62 according to a third embodiment is shown in FIG. 5.

Advantageously, the detection system 62 according to this third embodiment not only makes it possible to determine the front or rear position of a child seat 20 intended for a child over 18 months of age, but also to determine whether the child seat mounted on the passenger seat of the vehicle is a seat for children over 18 months of age or a child seat for children under 18 months of age.

The detection system 62 according to this third embodiment is identical to the detection system 2 according to the first embodiment, except that it also comprises an additional capacitive sensor 64 arranged on the backrest, and the processing unit implements a method according to a third embodiment. The additional capacitive sensor 64 is a capacitive sensor 64 with coplanar interdigital electrodes. The additional capacitive sensor 64 is located at a third distance D3 from the seat. The third distance D3 is measured between the rear part of the substantially horizontal face of the seat and the lower part of the capacitive sensor, as shown in FIG. 3. The third distance is the smallest distance between the substantially horizontal part of the seat and the lower part of the capacitive sensor. The third distance D3 is measured along the X axis.

The third distance D3 is between 20 centimeters and 30 centimeters. Memory 28 includes instructions 66 for implementing the steps of the detection method according to the third embodiment described below.

The other technical elements of the detection system 48 according to the third embodiment are identical to the technical elements of the detection system 2 according to the first embodiment; they bear the same references and will not be described a second time.

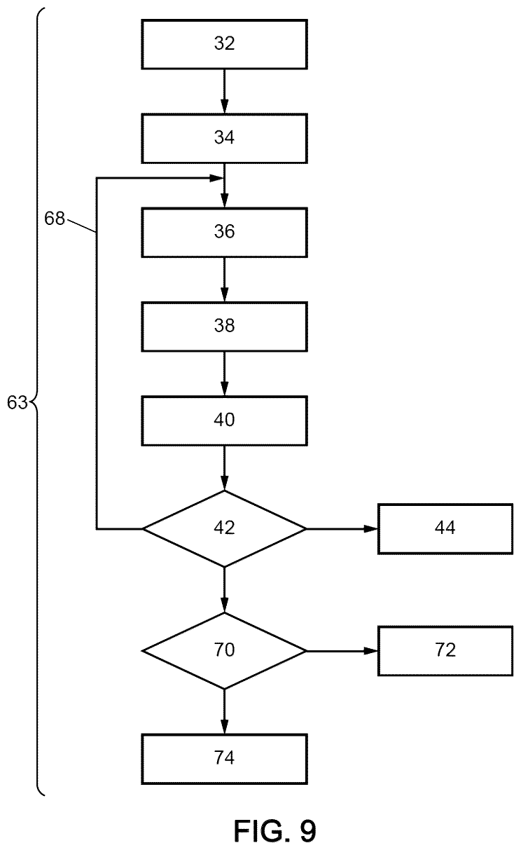

The detection method according to the third embodiment of the present disclosure 63 is implemented by the detection system according to the third embodiment. The detection method according to the third embodiment is shown in FIG. 9. It is identical to the detection method according to the first embodiment, except that during the measurement phase 32, capacitive values are measured by the processing unit at the electrodes of the first capacitive sensor 6 and at the electrodes of the additional capacitive sensor 64.

Steps 34 to 42 are then carried out in the same way as in the detection method according to the first embodiment.

If, during step 42, the first variation Δ1 is greater than the first threshold Se1, a first signal Sig1 indicative of a detection of a front position of the child seat is transmitted by the processing unit, during step 44.

If, during step 42, the first variation Δ1 is less than the first threshold Se1, the method returns to step 36, in a step 68.

In this new step 36, the processing unit calculates a third mean value M3 from the capacitive values measured at the electrodes of the additional capacitive sensor 64 during the first period.

In this new step 38, the processing unit calculates a fourth mean value M4 from the capacitive values measured at the electrodes of the additional capacitive sensor 64 during the second period.

In a new step 40, the difference between the fourth mean value M4 and the third mean value M3 is calculated. This difference is called a second variation Δ2.

Then, in step 70, the second variation Δ2 is compared with the first threshold Sel.

If the second variation 42 is greater than the first threshold Se1, a second signal Sig2 is transmitted by the processing unit 10 in a step 72. This second signal Sig2 is indicative of the fact that the child seat mounted on the vehicle's passenger seat is a child seat intended for a child under eighteen months of age.

If the second variation Δ2 is less than the first threshold Se1, then a fourth signal Sig4 is transmitted by the processing unit 10 in a step 74.

This fourth Sig4 signal is indicative of the fact that a child seat over 18 months of age is arranged in a rear position.

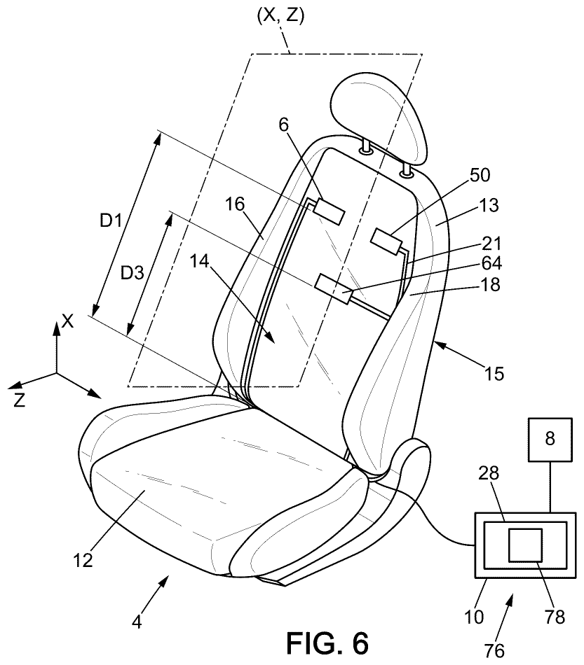

A detection system 76 according to a fourth embodiment is shown in FIG. 6.

Like the detection system according to the third embodiment, this detection system 76 also makes it possible to determine the position of a child seat 20 intended for a child over 18 months of age between the so-called “front position” and the so-called “rear position” but also to determine whether the child seat mounted on the passenger seat of the vehicle is a seat for children over 18 months of age or a child seat for children under 18 months of age.

The detection system 76 according to this fourth embodiment is identical to the detection system 2 according to the second embodiment, with the exception that it also comprises an additional capacitive sensor 64 arranged on the backrest, and that the processing unit implements a method comprising steps of the method 49 according to the second embodiment and steps of the method 63 according to the third embodiment. The additional capacitive sensor 64 is identical to the capacitive sensor 64 described in the detection system according to the third embodiment. Memory 28 includes instructions 78 for implementing the steps of a method comprising steps of method 49 according to the second embodiment and steps of method 63 according to the third embodiment.

The other technical elements of the detection system 76 according to the fourth embodiment are identical to the technical elements of the detection systems according to the second embodiment and the third embodiment; they bear the same references and will not be described again.

To increase passenger safety, safety systems have become mandatory in the front of vehicles. These safety systems include, for example, a dashboard airbag and/or a door airbag.

Child seats can be attached to the front passenger seat of a motor vehicle either in a so-called “facing the road” position, as shown in FIG. 1, or in a so-called “back to the road” position, as shown in FIG. 2. In the “back to the road” position, the child faces the backrest. This position is safer for the child because the airbag deployment will not injure the child, but the driver has poor visibility of the child while driving. In the “facing the road” position, also referred to as front position, the child faces the vehicle's dashboard. In this position, the driver can see and monitor the child while driving, but the deployment of an air bag could injure the child. This position is less safe for the child. There are comparative devices and methods for automatically detecting the presence of a child seat on a motor vehicle seat. However, these comparative devices and methods do not indicate whether the child seat is in a “back to the road” or “facing the road” position.

It would be advisable to know in which position the child seat has been secured, so as to be able to adapt the airbag inflation strategy, for example by blocking airbag inflation or by adapting the injection speed or the quantity of air injected, in order to reduce the impact between the airbag and the child, when the child seat is installed in the “facing the road” position.

A first purpose of the present disclosure is to propose a method and system for detecting the position of a child seat, when the child seat is more than 18 months old.

A second purpose of the present disclosure is to detect whether the child seat to install on the seat is a seat for children under 18 months of age.

The present disclosure relates to a method for detecting a so-called front position or a so-called rear position of a child seat arranged on a vehicle seat; the method being implemented by a detection system comprising a vehicle seat having a seat and a backrest having a front face with two longitudinal edges, at least one first capacitive sensor with coplanar interdigital electrodes attached to the backrest at a first distance from the seat, a detection device able to detect the presence of a child seat on the vehicle seat, and a processing unit connected to the at least one first capacitive sensor and to the detection device; the first distance being between 30 centimeters and 45 centimeters; the method comprising a measurement phase during which capacitive values are measured at the electrodes of the at least one first capacitive sensor; upon detection of the presence of a child seat on the vehicle seat, the method further comprising the following steps:
a) calculating a first mean value from the capacitive values measured during a first period of the measurement phase,
b) calculating a second mean value of the capacitive values measured during a second period of the measurement phase, the second period being subsequent to the first period,
c) calculating a first variation between the second mean value and the first mean value,
d) comparing the first variation with a first threshold,
e) transmitting a first signal indicative of a detection of a front position of the child seat, when the first variation is greater than the first threshold.

The features disclosed in the following paragraphs may optionally be implemented. They can be implemented independently of one another or in combination with one another:
The first threshold is between 15 picofarads and 50 picofarads.
The detection system comprises a second capacitive sensor with coplanar interdigital electrodes arranged on the backrest, the first and second capacitive sensors being arranged on either side of a central longitudinal plane; the central longitudinal plane extending vertically, between and halfway between the two longitudinal edges; steps a) to d) being implemented by the processing unit based on the capacitance values measured at the electrodes of the second capacitive sensor, a first signal representing a detection of a front position of the child seat being transmitted only if the first variation calculated based on the capacitive values from the first capacitive sensor and the first variation calculated based on the capacitive values from the second capacitive sensor are each greater than the first threshold.
The detection system further comprises at least one additional coplanar interdigital electrode capacitive sensor arranged on the backrest; the additional capacitive sensor being located at a third distance from the seat, the third distance being between 20 centimeters and 30 centimeters; capacitive values being measured at the electrodes of the at least one additional capacitive sensor during the measurement phase, and wherein, when the at least one first variation is below the first threshold, the method further comprises the following steps:
calculating a third mean value from the capacitive values measured by the additional capacitive sensor during the first period,
calculating a fourth mean value from the capacitive values measured by the additional capacitive sensor during the second period,
calculating a second variation between the fourth mean value and the third mean value,
comparing the second variation with the first threshold;
transmitting a second signal indicating that the child seat is intended for a child under eighteen months of age.

The present disclosure also relates to a system for detecting a front or rear position of a child seat arranged on a vehicle seat, the detection system comprising:
a vehicle seat comprising a seat and a backrest, the backrest having two longitudinal edges,
at least one first coplanar interdigital capacitive sensor arranged on the backrest at a first distance from the seat, the first distance being between 30 centimeters and 45 centimeters from the seat,
a detection device able to detect the presence of a child seat on the vehicle seat,
a data processing unit connected to the at least one first capacitive sensor and to the detection device, the processing unit comprising a memory including instructions for implementing the above-described method.

The features disclosed in the following paragraphs may optionally be implemented. They can be implemented independently of one another or in combination with one another:
The at least one first capacitive sensor is arranged midway between the longitudinal edges of the front face of the vehicle seat back.
The system further comprises a second capacitive sensor with coplanar interdigital electrodes arranged on the backrest, the first and second capacitive sensors being arranged on either side of a central longitudinal plane; the central longitudinal plane extending vertically between and midway between the two longitudinal edges; the memory comprising instructions for implementing the steps of the method described above.
The first capacitive sensor and the second capacitive sensor are separated from the central longitudinal plane by a second distance of between 1 centimeter and 5 centimeters.
The detection system further comprises at least one additional coplanar interdigital electrode capacitive sensor arranged on the backrest; the additional capacitive sensor being located at a third distance from the seat, the third distance being between 20 centimeters and 30 centimeters; the memory comprising instructions for implementing the steps of the method described above.
The additional capacitive sensor is arranged midway between the longitudinal edges of the front face of the vehicle seat back.

The present disclosure relates to a method for detecting a so-called front position or a so-called rear position of a child seat arranged on a vehicle seat; the method further comprising the following steps:
a) calculating (36) a first mean value from the capacitive values measured during a first period of the measurement phase,
b) calculating (38) a second mean value of the capacitive values measured during a second period of the measurement phase, the second period being subsequent to the first period,
c) calculating (40) a first variation between the second mean value and the first mean value,
d) comparing (42) the first variation with a first threshold,
e) transmitting (44) a first signal indicative of a detection of a forward position of the child seat, when the first variation is greater than the first threshold. The present disclosure also relates to an associated detection system.

1. A method for detecting a so-called front position or a so-called rear position of a child seat arranged on a vehicle seat; the method being implemented by a detection system comprising a vehicle seat having a seat and a backrest having a front face with two longitudinal edges, at least one first capacitive sensor with coplanar interdigital electrodes attached to the backrest at a first distance from the seat, a detection device able to detect the presence of a child seat on the vehicle seat, and a processing unit connected to the at least one first capacitive sensor and to the detection device; the first distance being between 30 centimeters and 45 centimeters; the method comprising a measurement phase during which capacitive values are measured at the electrodes of the at least one first capacitive sensor; upon detection of the presence of a child seat on the vehicle seat, the method further comprising the following steps:
a) calculating a first mean value from the capacitive values measured during a first period of the measurement phase,
b) calculating a second mean value of the capacitive values measured during a second period of the measurement phase, the second period being subsequent to the first period,
c) calculating a first variation between the second mean value and the first mean value,
d) comparing the first variation with a first threshold,
e) transmitting a first signal indicative of a detection of a front position of the child seat, when the first variation is greater than the first threshold.

2. The detection method according to claim 1, wherein the first threshold is between 15 picofarads and 50 picofarads.

3. The detection method according to claim 1, wherein the detection system comprises a second capacitive sensor with coplanar interdigital electrodes arranged on the backrest, the first and second capacitive sensors being arranged on either side of a central longitudinal plane; the central longitudinal plane extending vertically, between and halfway between the two longitudinal edges; steps a) to d) being implemented by the processing unit based on the capacitance values measured at the electrodes of the second capacitive sensor, a first signal indicative of a detection of a front position of the child seat being transmitted only if the first variation calculated based on the capacitive values from the first capacitive sensor and the first variation calculated based on the capacitive values from the second capacitive sensor are each greater than the first threshold.

4. The detection method according to claim 1, wherein the detection system further comprises at least one additional capacitive sensor with coplanar interdigital electrodes arranged on the backrest; the additional capacitive sensor being located at a third distance from the seat, the third distance being between 20 centimeters and 30 centimeters; capacitive values being measured at the electrodes of the at least one additional capacitive sensor during the measurement phase, and wherein when the at least one first variation is less than the first threshold, the method further comprises the following steps:
calculating a third mean value from the capacitive values measured by the additional capacitive sensor during the first period,
calculating a fourth mean value from the capacitive values measured by the additional capacitive sensor during the second period,
calculating a second variation between the fourth mean value and the third mean value,
comparing the second variation with the first threshold;
transmitting a second signal indicative of the fact that the child seat is a child seat intended for a child under eighteen months of age.

5. A system for detecting a front position or a rear position of a child seat arranged on a vehicle seat, the detection system comprising:
a vehicle seat comprising a seat and a backrest, the backrest having two longitudinal edges,
at least one first capacitive sensor with coplanar interdigital electrodes arranged on the backrest at a first distance from the seat, the first distance being between 30 centimeters and 45 centimeters from the seat,
a detection device able to detect the presence of a child seat on the vehicle seat,
a data processing unit connected to the at least one first capacitive sensor and to the detection device, the processing unit comprises a memory including instructions for implementing the method according to claim 1.

6. A system for detecting a front position or a rear position of a child seat arranged on a vehicle seat, the detection system comprising:
a vehicle seat comprising a seat and a backrest, the backrest having two longitudinal edges,
at least one first capacitive sensor with coplanar interdigital electrodes arranged on the backrest at a first distance from the seat, the first distance being between 30 centimeters and 45 centimeters from the seat,
a detection device able to detect the presence of a child seat on the vehicle seat,
a data processing unit connected to the at least one first capacitive sensor and to the detection device, the processing unit comprises a memory including instructions for implementing the method according to claim 2.

7. The detection system according to claim 5, wherein the at least one first capacitive sensor is arranged midway between the longitudinal edges of the front face of the vehicle seat backrest.

8. A system for detecting a front position or a rear position of a child seat arranged on a vehicle seat, the detection system comprising:
a vehicle seat comprising a seat and a backrest, the backrest having two longitudinal edges,
at least one first capacitive sensor with coplanar interdigital electrodes arranged on the backrest at a first distance from the seat, the first distance being between 30 centimeters and 45 centimeters from the seat,
a detection device able to detect the presence of a child seat on the vehicle seat,
a data processing unit connected to the at least one first capacitive sensor and to the detection device,
a second capacitive sensor with coplanar interdigital electrodes arranged on the backrest, the first and second capacitive sensors being arranged on either side of a central longitudinal plane; the central longitudinal plane extending vertically between and midway between the two longitudinal edges;
wherein the data processing unit comprises a memory including instructions for implementing the method according to claim 3.

9. The detection system according to claim 8, wherein the first capacitive sensor and the second capacitive sensor are spaced apart from the central longitudinal plane by a second distance of between 1 centimeter and 5 centimeters.

10. A system for detecting a front position or a rear position of a child seat arranged on a vehicle seat, the detection system comprising:
a vehicle seat comprising a seat and a backrest, the backrest having two longitudinal edges,
at least one first capacitive sensor with coplanar interdigital electrodes arranged on the backrest at a first distance from the seat, the first distance being between 30 centimeters and 45 centimeters from the seat,
a detection device able to detect the presence of a child seat on the vehicle seat,
a data processing unit connected to the at least one first capacitive sensor and to the detection device,
wherein the detection system further comprises at least one additional coplanar interdigital electrode capacitive sensor arranged on the backrest; the additional capacitive sensor being located at a third distance from the seat, the third distance being between 20 centimeters and 30 centimeters; and
wherein the processing unit comprises a memory including instructions for implementing the method according to claim 4.

11. The detection system according to claim 10, wherein the additional capacitive sensor is arranged midway between the longitudinal edges of the front face of the vehicle seat back.
